(19) United States
(12) Patent Application Publication
(10) Pub. No.: US 2023/0247491 A1
(43) Pub. Date: Aug. 3, 2023

(54) TERMINAL APPARATUS AND METHOD FOR CONTROLLING TERMINAL APPARATUS

(71) Applicant: NTT DOCOMO, INC., Chiyoda-ku (JP)

(72) Inventors: Daiki TAKEDA, Chiyoda-ku (JP); Hiroki ISHIZUKA, Chiyoda-ku (JP); Masashi ANZAWA, Chiyoda-ku (JP)

(73) Assignee: NTT DOCOMO, INC., Chiyoda-ku (JP)

(21) Appl. No.: 17/998,509

(22) PCT Filed: May 6, 2021
(86) PCT No.: PCT/JP2021/017416

§ 371 Date: Nov. 11, 2022

(30) Foreign Application Priority Data
May 26, 2020 (JP) 2020-091351

(51) Int. Cl. H04W 28/24; H04W 8/18

(52) U.S. Cl. CPC H04W 28/24; H04W 8/18

(57) ABSTRACT

A terminal apparatus to be connected to a network among a plurality of networks in which quality of a communication service is to be controlled has an identifier and a requester. The identifier is configured to identify, based on network information for identifying the network, one or both of a quality control apparatus and a notification apparatus. The quality control apparatus is configured to receive a request regarding QoS control that is control of quality of a communication service in the network, and the notification apparatus is configured to receive a request to acquire interface to information including information indicative of the quality control apparatus. The requester is configured to request the quality control apparatus to start the QoS control.

### TECHNICAL FIELD

The present invention relates to a terminal apparatus and to a method for controlling a terminal apparatus.

### BACKGROUND ART

For example, Patent Document 1 discloses a system that implements, for data communications between a terminal apparatus such as a smartphone and a network, Quality of Service (QoS) control according to a QoS level requested by the terminal apparatus.

### RELATED ART DOCUMENT

### Patent Document

Patent Document 1: Japanese Patent Application Laid-Open Publication No. 2014-33446

### SUMMARY OF THE INVENTION

### Problem to be Solved by the Invention

For example, specifications in requesting implementation of QoS control (e.g., information to be notified to a communication carrier in requesting implementation of QoS control, an access destination of a request, etc.) are stipulated by a communication carrier that manages a communication network such as a network. In a plurality of networks respectively managed by a plurality of communication carriers, therefore, specifications in requesting implementation of QoS control differ for each network in some cases. Therefore, for example, in a case in which an application carrier that provides an application program to be installed in a terminal apparatus creates an application program such that the implementation of the QoS control can be requested in each of the plurality of networks, the application program is complicated, which is problematic.

### Means of Solving the Problem

In order to solve the problem described above, a terminal apparatus according to a preferred aspect of the present invention is a terminal apparatus to be connected to a network among a plurality of networks in which quality of a communication service is controlled, the terminal apparatus including: an identifier configured to identify, based on network information for identifying the network, one or both of a first node and a second node, wherein: the first node is configured to receive a request regarding quality control that is control of quality of a communication service in the network, and the second node is configured to receive a request to acquire first information including information indicative of the first node; and a requester configured to request the first node to start the quality control.

### Effects of Invention

According to the present invention, in creating an application program that can request implementation of QoS control in each of a plurality of networks, the application program is less likely to be complicated.

### BRIEF DESCRIPTION OF THE DRAWINGS

FIG. 1 is a block diagram illustrating a general configuration of a network system including a terminal apparatus according to an embodiment.

FIG. 2 is an explanatory diagram illustrating one example of a correspondence table illustrated in FIG. 1.

FIG. 3 is an explanatory diagram illustrating one example of interface information.

FIG. 4 is an explanatory diagram illustrating one example of network information.

FIG. 5 is a sequence chart illustrating one example of operation of the network system illustrated in FIG. 1.

FIG. 6 is a block diagram illustrating a general configuration of a network system including a terminal apparatus according to a first modification example.

FIG. 7 is an explanatory diagram illustrating one example of a correspondence table illustrated in FIG. 6.

### MODES FOR CARRYING OUT THE INVENTION

### 1. Embodiment

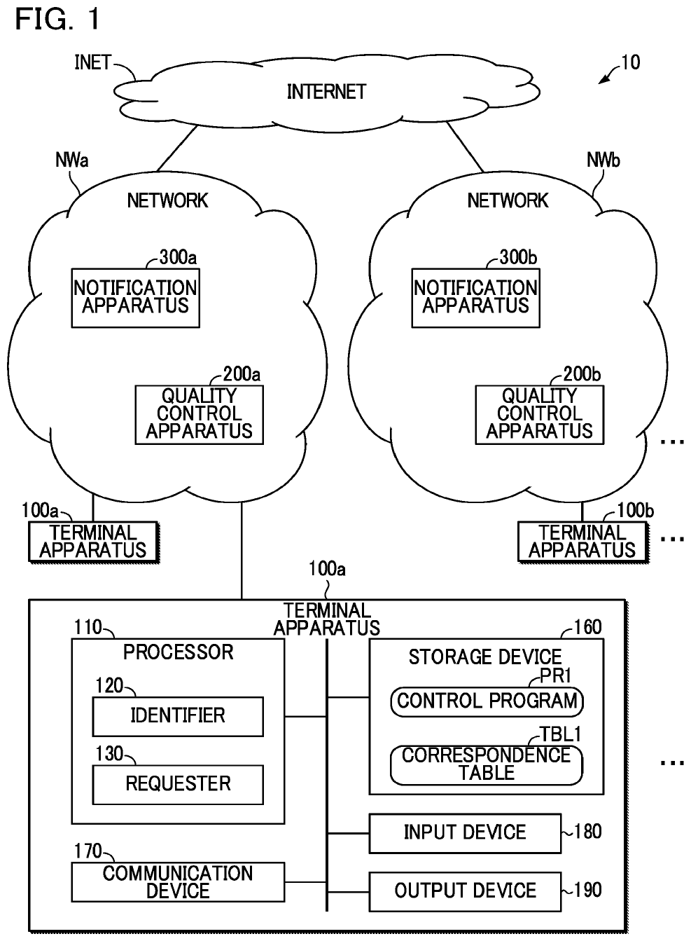

FIG. 1 is a block diagram illustrating a general configuration of a network system 10 including a terminal apparatus 100 according to an embodiment. As illustrated in FIG. 1, the network system 10 includes a plurality of networks NW connected to each other via the Internet INET, and a plurality of terminal apparatuses 100 respectively connected to the plurality of networks NW. It should be noted that the term “apparatus” in the present specification may be replaced with another term such as circuit, device, or unit.

For example, the plurality of networks NW are electronic communication lines, such as mobile communication networks, to be each managed by a plurality of communication carriers, each providing a communication service. Each of the plurality of networks NW includes one or both of a wired network and a wireless network. For example, the management of each network NW includes use of the network NW.

However, in a case in which the corresponding communication carrier is a virtual mobile communication carrier, for example, the management of the network NW does not include use of a wireless station, such as a base station, included in the network NW in some cases, and does not include wired use in some cases.

Although not particularly illustrated in FIG. 1, the plurality of networks NW each includes a plurality of nodes. Examples of the plurality of nodes included in the respective networks NW include a base station (eNodeB, gNodeB, etc.), a mobility management entity (MME), a serving gateway (S-GW), a packet data network gateway (P-GW), and the like. The eNodeB is a base station for long term evolution (LTE), and the gNodeB is a base station for 5th generation (5G) mobile communication system. It should be noted that the plurality of nodes included in the respective networks NW are not limited to a base station, an MME, an S-GW, and a P-GW.

It is assumed in the example illustrated in FIG. 1 that one of the plurality of nodes included in the respective networks NW is a quality control apparatus 200 and another one of the plurality of nodes is a notification apparatus 300. That is, each of the plurality of networks NW includes a quality control apparatus 200 and a notification apparatus 300. Each quality control apparatus 200 is an example of “a first node”, and each notification apparatus 300 is an example of “a second node”.

For example, the connection among the plurality of networks NW, the connection between each network NW and the corresponding terminal apparatus 100, and other connections may be established in one or both of a wired manner and a wireless manner as long as these connections each allow a plurality of elements to communicate with each other.

It should be noted that as illustrated in FIG. 1, a lower-case letter of the alphabet (a or b) is added to the reference sign “NW” of each network in order to distinguish the plurality of networks NW from each other. In addition, the same lower-case letter of the alphabet (a or b) is also added to the reference sign “200” of each quality control apparatus included in the corresponding network NW, the reference sign “300” of each notification apparatus included in the corresponding network NW, and the reference sign “100” of each terminal apparatus connected to the corresponding network NW.

For example, the network NWa is managed by a communication carrier different from a communication carrier managing the network NWb. For example, the terminal apparatus 100a is the terminal apparatus 100 connected to the network NWa, and the terminal apparatus 100b is the terminal apparatus 100 connected to the network NWb. For example, a given information processing apparatus can be adopted as each terminal apparatus 100. Each terminal apparatus 100 may be a stationary information device such as a personal computer, or it may be a portable information terminal such as a smartphone, a notebook personal computer, a wearable terminal, or a tablet terminal. It is assumed in the following description that each terminal apparatus 100 is a smartphone.

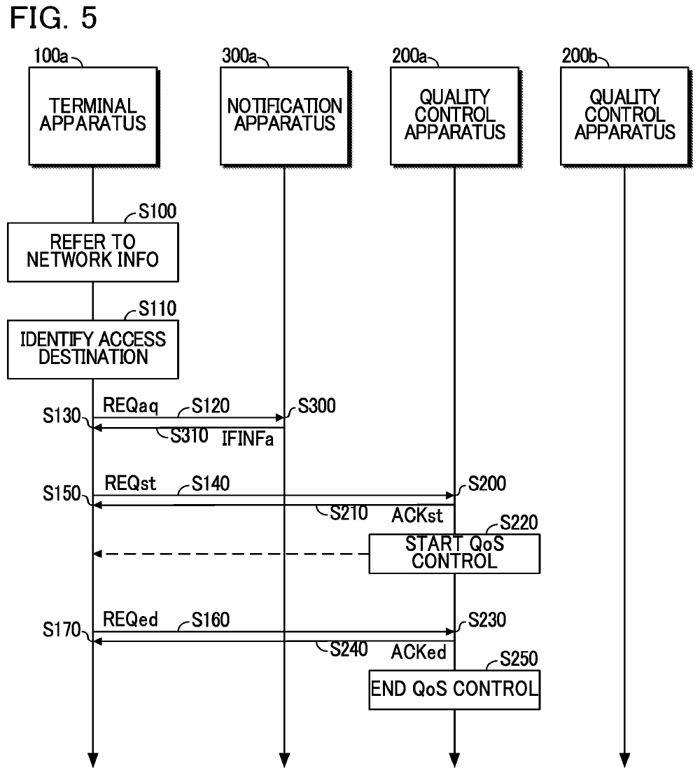

For example, the quality control apparatus 200a is a node among the plurality of nodes included in the network NWa. The quality control apparatus 200a receives a request regarding quality control that is control of quality of a communication service in the network NWa. For example, when receiving a start request REQst to request a start of quality control, the quality control apparatus 200a starts quality control that is control of quality of a communication service in the network NWa (see S200 and S220 in FIG. 5). For example, the notification apparatus 300a is another node among the plurality of nodes included in the network NWa. The notification apparatus 300a receives an acquisition request REQaq to acquire interface information IFINF (IFINFa) including information indicative of the quality control apparatus 200a (see S300 in FIG. 5). The interface information IFINF is one example of “first information”. An example of the interface information IFINF will be described later with reference to FIG. 3.

Likewise, for example, the quality control apparatus 200b is a node among the plurality of nodes included in the network NWb. The quality control apparatus 200b receives a request regarding quality control that is control of quality of a communication service in the network NWb. For example, the notification apparatus 300b is another node among the plurality of nodes included in the network NWb. The notification apparatus 300b receives an acquisition request REQaq to acquire interface information IFINF (IFINFb) including information indicative of the quality control apparatus 200b.

A request regarding processing such as quality control may be calling up an application programming interface (API) regarding the processing. For example, requesting a start of quality control may be causing a requester 130 to implement call-up of a start API for quality control on a quality control apparatus 200. In other words, in the present embodiment, transmitting a start request REQst includes calling up a start API for quality control, and transmitting an acquisition request REQaq includes calling up an acquisition API for interface information IFINF.

It is assumed in the present embodiment that control of quality of a communication service in each network NW to which the plurality of terminal apparatuses 100 are connected is implementable for each terminal apparatus 100. In the following, quality control that is control of quality of a communication service is also referred to as Quality of Service (QoS) control. For example, the QoS control includes band control, low latency control, priority control, and the like. For example, the band control controls a communication band in each network NW. The band control may be band assurance by which a lower limit value is set for a band, or it may be band restriction by which an upper limit value is set for a band. Likewise, for example, the low latency control may be latency assurance by which an upper limit value is set for latency or may be latency restriction by which a lower limit value is set for latency. For example, the priority control preferentially transfers a packet related to a specific communication (data on a transfer basis in establishing communications). For example, priorities are given to packets flowing on each network NW, and a packet with a higher priority is processed prior to a packet with a lower priority.

For example, each terminal apparatus 100 is implemented using a computer system including a processor 110, a storage device 160, a communication device 170, an input device 180, and an output device 190. The plurality of elements of the terminal apparatus 100 are mutually connected with one or more buses for communicating information. Each of the plurality of elements of the terminal apparatus 100 may be configured with one or more devices. Alternatively, some of the elements of the terminal apparatus 100 may be omitted.

The processor 110 controls the entire terminal apparatus 100 and includes, for example, one or more chips. For example, the processor 110 is configured with a central processing unit (CPU) including an interface with a peripheral apparatus, an arithmetic-logic unit, a register, and the like. It should be noted that some or all of the functions of the processor 110 may be implemented using hardware such as a digital signal processor (DSP), an application specific integrated circuit (ASIC), a programmable logic device (PLD), and a field programmable gate array (FPGA). The processor 110 implements various kinds of processing in parallel or in succession.

For example, the processor 110 reads a control program PR1 from the storage device 160 and implements the read control program PR1, thereby functioning as an identifier 120 and a requester 130. It should be noted that the control program PR1 may be transmitted from another apparatus via the corresponding network NW.

The identifier 120 identifies one or both of the quality control apparatus 200 and the notification apparatus 300 included in the network NW to which the terminal apparatus 100 is connected, based on network information for identifying the network NW to which the terminal apparatus 100 is connected. Examples of the network information include subscriber identity module (SIM) information stored in a SIM, an access point name (APN) identifying an access point for connection to the network NW, and the like. The SIM is one example of “a module configured to store subscriber identification information”. An example of the network information will be described later with reference to FIG. 4.

Identifying one or both of the quality control apparatus 200 and the notification apparatus 300 may be, for example, identifying an address of one of, or addresses of both of, the quality control apparatus 200 and the notification apparatus 300, or may be identifying a host name of one of, or host names of both of, the quality control apparatus 200 and the notification apparatus 300. The address of the quality control apparatus 200 may be an internet protocol (IP) address of the quality control apparatus 200 or may be a uniform resource locator (URL) of the API of the quality control apparatus 200. Likewise, the address of the notification apparatus 300 may be an IP address of the notification apparatus 300 or may be a URL of the API of the notification apparatus 300.

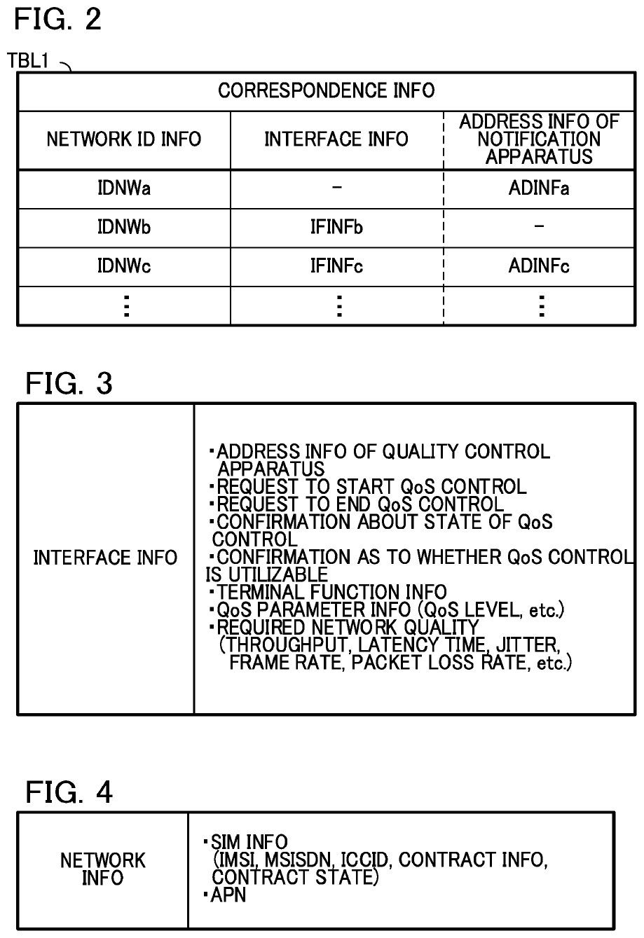

For example, the identifier 120 identifies a communication carrier managing the network NW to which the terminal apparatus 100 is connected, based on the SIM information, the APN, or the like included in the network information. The identifier 120 then identifies the address of one of, or the addresses of both of, the quality control apparatus 200 and the notification apparatus 300, based on a correspondence table TBL1 stored in the storage device 160. For example, the correspondence table TBL1 stores one or both of interface information IFINF of the quality control apparatus 200 and address information ADINF indicative of the address of the notification apparatus 300, for each network NW (e.g., for each communication carrier managing the corresponding network NW) (see FIG. 2).

It should be noted that the address information ADINF indicative of the address of each notification apparatus 300 is one example of “second information”. Another example of “second information” may be information indicative of the host name of each notification apparatus 300. Likewise, the address information indicative of the address of each quality control apparatus 200 is one example of “information indicative of a first node” and another example of “the information indicative of the first node” may be information indicative of the host name of each quality control apparatus 200. It is assumed in the present embodiment that identifying one or both of the quality control apparatus 200 and the notification apparatus 300 corresponds to identifying the address of one of, or the addresses of both of, the quality control apparatus 200 and the notification apparatus 300.

For example, in a case in which the correspondence table TBL1 is managed by an external system, the identifier 120 may acquire the correspondence table TBL1 from the external system and store the correspondence table TBL1 acquired from the external system, in the storage device 160. For example, the external system may be one of the notification apparatus 300 and the quality control apparatus 200 managed by each of the plurality of communication carriers. Alternatively, a management apparatus different from the notification apparatus 300 and the quality control apparatus 200 may be provided as the external system in each of the plurality of communication carriers. As another alternative, a common management apparatus to the plurality of communication carriers may be provided as the external system. The correspondence table TBL1 may be released on the Internet INET and the like.

For example, the requester 130 transmits a start request REQst to request a start of QoS control, to the quality control apparatus 200. For example, when the identifier 120 identifies the address of the quality control apparatus 200, the requester 130 transmits the start request REQst to the address of the quality control apparatus 200 identified by the identifier 120.

When the identifier 120 identifies the address of the notification apparatus 300, of the address of the quality control apparatus 200 and the address of the notification apparatus 300, the requester 130 requests the notification apparatus 300 to acquire the interface information IFINF of the quality control apparatus 200. For example, the requester 130 transmits an acquisition request REQaq to request acquisition of the interface information IFINF of the quality control apparatus 200, to the address of the notification apparatus 300 identified by the identifier 120. The requester 130 then requests the quality control apparatus 200 to start the QoS control, based on the interface information IFINF acquired from the notification apparatus 300. For example, the requester 130 transmits the start request REQst to the address of the quality control apparatus 200 identified based on the interface information IFINF acquired from the notification apparatus 300.

For example, the requester 130 transmits, in requesting an end of the QoS control, an end request REQed to request an end of the QoS control, to the quality control apparatus 200 (see S160 in FIG. 5). It should be noted that transmitting the end request REQed includes calling up an end API for the QoS control.

The storage device 160 is a recording medium readable by the processor 110 and stores various kinds of data such as the correspondence table TBL1 and a plurality of programs including the control program PR1 to be implemented by the processor 110. The storage device 160 may also store an APN. For example, the storage device 160 may be configured with at least one of a read only memory (ROM), an erasable programmable ROM (EPROM), an electrically erasable programmable ROM (EEPROM), a random access memory (RAM), and the like. The storage device 160 may also be called a register, a cache memory, a main memory (a main storage device), or the like. It should be noted that the storage device 160 is one example of “a storage device”.

The communication device 170 is hardware (a transmitter receiver device) for communicating with other apparatuses such as the quality control apparatus 200 and the notification apparatus 300 via the network NW. For example, the communication device 170 is also called a network device, a network controller, a network card, a communication module, or the like. For example, the communication device 170 may be configured including a high-frequency switch, a duplexer, a filter, a frequency synthesizer, and the like in order to achieve one or both of frequency division duplex (FDD) and time division duplex (TDD).

The input device 180 receives an external input, and examples of the input device 180 include a keyboard, a mouse, a microphone, a switch, a button, a sensor, and the like. For example, the input device 180 receives an operation for inputting codes such as numerals and characters into the processor 110 and an operation for selecting an icon displayed on a display surface of the terminal apparatus 100. For example, the input device 180 is preferably a touch panel that detects a touch on the display surface of the terminal apparatus 100. It should be noted that the input device 180 may include a plurality of operators operable by a user.

The output device 190 may be a display that performs external output. For example, the output device 190 displays an image under the control by the processor 110. Preferable examples of the output device 190 may include various display panels such as a liquid crystal display panel and an organic electroluminescent (EL) display panel. It should be noted that the input device 180 and the output device 190 may be integrated together (e.g., be a touch panel). The output device 190 may include a speaker, a light emitting diode (LED) lamp, and the like.

For example, each quality control apparatus 200 is an information processing apparatus such as a server communicable with the plurality of terminal apparatuses 100 connected to the corresponding network NW, and implements QoS control. For example, when the quality control apparatus 200 receives a start request REQst to request a start of QoS control of one of the terminal apparatuses 100, the quality control apparatus 200 implements the QoS control at a QoS level designated by the start request REQst, on communications by the terminal apparatus 100. Examples of the QoS level may include a large capacity mode that enables larger capacity data transfer than other quality modes, a low latency mode that enables smaller data latency than other quality modes, a best effort mode that achieves control based on a best effort, and the like. The quality control apparatus 200 may be communicable with the corresponding notification apparatus 300. For example, the QoS level may be designated by, in addition to the terminal apparatus 100, a node such as the notification apparatus 300 included in the network NW.

For example, in implementing the QoS control at the QoS level designated by the start request REQst, the quality control apparatus 200 transmits an acknowledgement ACKst to the start request REQst, to the terminal apparatus 100 (see S210 in FIG. 5). In a case in which the QoS control at the QoS level designated by the start request REQst is not implementable, the quality control apparatus 200 may transmit a negative acknowledgement to the start request REQst, to the terminal apparatus 100.

Although not particularly illustrated in FIG. 1, for example, each quality control apparatus 200 is implemented using a computer system including a processor that controls the entire quality control apparatus 200, a storage device that stores various kinds of data, and a communication device for communicating with another apparatus. For example, each quality control apparatus 200 may include an input device and an output device, as in each terminal apparatus 100. Each quality control apparatus 200 may be implemented as a single apparatus or may be implemented as a set of a plurality of devices configured separately from one another. In each quality control apparatus 200, for example, a function of receiving a start request REQst and the like and a function of implementing QoS control may be implemented as a single apparatus or may be implemented as a set of two devices configured separately from each other. Each quality control apparatus 200 may alternatively include a plurality of devices that implement QoS control.

For example, each notification apparatus 300 is an information processing apparatus such as a server communicable with the plurality of terminal apparatuses 100 connected to the corresponding network NW, and receives a request to acquire the interface information IFINF of the corresponding quality control apparatus 200. For example, when the notification apparatus 300 receives an acquisition request REQaq to request acquisition of the interface information IFINF of the quality control apparatus 200 from one of the plurality of terminal apparatuses 100, then the notification apparatus 300 transmits the interface information IFINF of the quality control apparatus 200 to the terminal apparatus 100 that is a transmission source of the acquisition request REQaq.

Although not particularly illustrated in FIG. 1, for example, each notification apparatus 300 is implemented using a computer system including a processor that controls the entire notification apparatus 300, a storage device that stores various kinds of data, and a communication device for communicating with another apparatus. For example, each notification apparatus 300 may include an input device and an output device, as in each terminal apparatus 100. Each notification apparatus 300 may be implemented as a single apparatus or may be implemented as a set of a plurality of devices configured separately from one another.

It should be noted that in the configurations of each terminal apparatus 100, quality control apparatus 200, and notification apparatus 300 are not limited to the exemplary configurations illustrated in FIG. 1. For example, each quality control apparatus 200 may achieve the functions of the corresponding notification apparatus 300. In this case, “a first node” is equal to “a second node”. For example, each terminal apparatus 100 may include an auxiliary storage device. The auxiliary storage device is a recording medium readable by the terminal apparatus 100. For example, the auxiliary storage device may be configured with at least one of an optical disc such as a compact disc ROM (CD-ROM), a hard disk drive, a flexible disc, a magneto-optical disc (e.g., a compact disc, a digital versatile disc, a Blu-ray (registered trademark) disc, etc.), a smart card, a flash memory (e.g., a card, a stick, a key drive, etc.), a floppy (registered trademark) disc, a magnetic strip, and the like. Likewise, one or both of each quality control apparatus 200 and each notification apparatus 300 may include an auxiliary storage device. Such an auxiliary storage device may be called a storage.

For example, each of the plurality of networks NW may include, in a case in which QoS control supports a plurality of services, a plurality of notification apparatuses 300 that differ for each service. Moreover, each network NW is not particularly limited as to whether the network NW is defined without including a terminal apparatus 100.

FIG. 2 is an explanatory diagram illustrating one example of the correspondence table TBL1 illustrated in FIG. 1. For example, the correspondence table TBL1 stores, for each network NW, correspondence information in which one or both of interface information IFINF and address information ADINF indicative of the address of the corresponding notification apparatus 300 is or are associated with network identification information IDNW identifying the network NW. For example, the network identification information IDNW is identified with network information. Specifically, the network identification information IDNW may be indicative of a communication carrier managing the network NW. It should be noted that the network information may be used as the network identification information IDNW. The network identification information IDNW is one example of “third information”.

For example, the correspondence table TBL1 includes a plurality of records having one-to-one correspondence with the plurality of networks NW. For example, each record in the correspondence table TBL1 stores the network identification information IDNW and one or both of the interface information IFINF of the quality control apparatus 200 included in the corresponding network NW indicated by the network identification information IDNW and the address information ADINF of the notification apparatus 300 included in the network NW.

For example, in the correspondence table TBL1 illustrated in FIG. 2, the record concerning the network NWa stores network identification information IDNWa indicative of the network NWa and address information ADINFa of the notification apparatus 300a. That is, the correspondence table TBL1 does not store interface information IFINFa of the quality control apparatus 200a. The record concerning the network NWb stores network identification information IDNWb indicative of the network NWb and interface information IFINFb of the quality control apparatus 200b. However, the record concerning the network NWb does not store address information ADINFb of the notification apparatus 300b. In addition, a record concerning a network NWc (not shown in FIG. 1) stores network identification information IDNWc indicative of the network NWc, interface information IFINFc of a quality control apparatus 200c, and address information ADINFc of a notification apparatus 300c.

In the present embodiment, the storage device 160 stores the correspondence table TBL1 and thereby stores the correspondence information in which one or both of the interface information IFINF of the quality control apparatus 200 and the address information ADINF of the notification apparatus 300 is or are associated with the network identification information IDNW.

In a case in which the correspondence table TBL1 is stored in the storage device 160 of one of the terminal apparatuses 100a connected to the network NWa, the networks NWb and NWc are each an example of “another network”. In this case, the quality control apparatuses 200b and 200c are each one example of “another first node”. The notification apparatuses 300b and 300c are each one example of “another second node”. The interface information IFINFb and the interface information IFINFc are each one example of “another first information”. The address information ADINFb and the address information ADINFc are each one example of “another second information”. The network identification information IDNWb and the network identification information IDNWc are each one example of “another third information”. In addition, the information stored in the record concerning the network NWb and the information stored in the record concerning the network NWc are each one example of “another correspondence information”. That is, in the present embodiment, the storage device 160 stores the correspondence table TBL1 and thereby stores “correspondence information” and “another correspondence information”.

It should be noted that the data configurations of the correspondence table TBL1 are not limited to the exemplary data configurations illustrated in FIG. 2. For example, in a case in which QoS control supports a plurality of services and one of the networks NW includes a plurality of notification apparatuses 300 that differ for each service, a record concerning the network NW may include a plurality of sub-records having one-to-one correspondence with the plurality of notification apparatuses 300. Likewise, in a case in which the network NW includes a plurality of quality control apparatuses 200 that differ for each service, the record concerning the network NW may include a plurality of sub-records having one-to-one correspondence with the plurality of quality control apparatuses 200. A method of storing correspondence information is not limited to the correspondence table TBL1 as long as one or both of interface information IFINF and address information ADINF can be identified from network identification information IDNW.

FIG. 3 is an explanatory diagram illustrating one example of interface information IFINF.

Interface information IFINF includes address information of a quality control apparatus 200 as described above with reference to FIG. 1. For example, the interface information IFINF also includes, in addition to the address information of the quality control apparatus 200, information about a request to start QoS control, a request to end QoS control, confirmation about a state of QoS control, confirmation as to whether QoS control is utilizable, acquisition of SIM information, and the like. For example, the interface information IFINF also includes terminal function information, QoS parameter information (QoS level, etc.), and information indicative of request network quality.

The terminal function information is indicative of a function of a terminal apparatus 100 and is required for receiving quality service to be achieved by QoS control. For example, in a case in which each quality control apparatus 200 supports QoS control by a QoS class identifier (QCI), the terminal function information may be indicative of a function of a corresponding one of the terminal apparatuses 100 for supporting the QoS control by the QCI. For example, in a case in which the quality control apparatus 200 supports QoS control of communications for multi-access edge computing (MEC), the terminal function information may be indicative of a function of the terminal apparatus 100 for supporting the QoS control of communications for the MEC. It should be noted that the terminal function information is not limited to the examples described above.

The QoS parameter information is indicative of a parameter to be notified to a quality control apparatus 200 in requesting a start of QoS control. For example, the QoS parameter information may be indicative of a quality mode (a QoS level, etc.) of QoS control to be required of the quality control apparatus 200. For example, in a case of QoS control by a QCI, the information indicative of the quality mode may be the QCI.

For example, the request network quality is network quality to be achieved by QoS control required of a quality control apparatus 200 or target network quality. For example, the network quality corresponds to a throughput, a latency time, jitter, a frame rate, a packet loss rate, and the like.

The items included in the interface information IFINF are not limited to the exemplary items illustrated in FIG. 3. For example, the interface information IFINF does not necessarily include some of the items illustrated in FIG. 3 as long as the interface information IFINF includes the address information of the quality control apparatus 200. Alternatively, the interface information IFINF may include some or all of the items illustrated in FIG. 3 and items different from the items illustrated in FIG. 3. Examples of the items different from the items illustrated in FIG. 3 include support information of QoS control, and the like. For example, the support information of the QoS control may be one or both of QCI support information indicative of whether the quality control apparatus 200 supports the QoS control by the QCI and MEC support information indicative of whether the quality control apparatus 200 supports the QoS control of communications for the MEC.

FIG. 4 is an explanatory diagram illustrating one example of network information. For example, the network information includes SIM information and an APN.

For example, the SIM information includes some or all of international mobile subscriber identity (IMSI), mobile subscriber integrated services digital network number (MSISDN), integrated circuit card ID (ICCID), contract information, and information indicative of a contract state.

For example, the IMSI is subscriber identification information identifying a user who subscribes to a communication service in a network NW. For example, the MSISDN is a telephone number stipulated by third generation partnership project (3GPP) standards and allocated to a subscriber (i.e., a telephone number associated with a SIM). For example, the ICCID is module identification information identifying a SIM.

For example, in a case in which a SIM is attached to each terminal apparatus 100, the identifier 120 of the terminal apparatus 100 refers to one, some, or all of the items included in the SIM information stored in the SIM, as network information, in order to identify one or both of the corresponding quality control apparatus 200 and the corresponding notification apparatus 300. The items included in the SIM information are not limited to the exemplary items illustrated in FIG. 4. For example, the SIM information may include some or all of the items illustrated in FIG. 4 and items different from the items illustrated in FIG. 4.

The items included in the network information are not limited to the exemplary items illustrated in FIG. 4. For example, the network information may be one of the SIM information and the APN. Alternatively, the network information may include IP address information indicative of an IP address of the terminal apparatus 100, in place of one or both of the SIM information and the APN. For example, since the IP address of the terminal apparatus 100 is given to the terminal apparatus 100 in order to utilize a communication service provided by the communication carrier, the IP address is utilizable for identifying the communication carrier. The network information may include some or all of the SIM information, the APN, and the IP address information of the terminal apparatus 100, and intonation different from the SIM information, the APN, and the IP address information of the terminal apparatus 100. For example, the information different from the SIM information, the APN, and the IP address information of the terminal apparatus 100 may be communication scheme information indicative of a communication scheme such as 3G, 4G, 5G, Wi-Fi (registered trademark), tethering, or wired communication.

FIG. 5 is a sequence chart illustrating one example of operation of the network system 10 illustrated in FIG. 1. It is assumed in the example illustrated in FIG. 5 that one of the plurality of terminal apparatuses 100a connected to the network NWa requests QoS control, among the plurality of terminal apparatuses 100 respectively connected to the plurality of networks NW. In the description referring to FIG. 5, therefore, the terminal apparatus 100a means a terminal apparatus 100a that requests QoS control, among the plurality of terminal apparatuses 100a connected to the network NWa unless otherwise specified. It is also assumed that the correspondence table TBL1 illustrated in FIG. 2 is utilized for the operation illustrated in FIG. 5.

First, the identifier 120 of the terminal apparatus 100a refers to network information in order to identify the address of one of, or the addresses of both of, the quality control apparatus 200a and the notification apparatus 300a included in the network NWa (S100). For example, the identifier 120 refers to one, some, or all of the items included in the SIM information stored in the SIM, as the network information. Alternatively, the identifier 120 may refer to the APN stored in the storage device 160 or the like of the terminal apparatus 100, as the network information.

The identifier 120 then identifies an access destination, based on the network information such as the SIM information (S110). Specifically, for example, the identifier 120 identifies, based on the network information, a communication carrier managing the network NWa to which the terminal apparatus 100a is connected, thereby identifying network identification information IDNWa of the network NWa. The identifier 120 then identifies one or both of interface information IFINFa and address information ADINFa associated with the network identification information IDNWa identified based on the network information, based on the correspondence table TBL1 stored in the storage device 160.

In the correspondence table TBL1 illustrated in FIG. 2, of the interface information IFINFa of the quality control apparatus 200a and the address information ADINFa of the notification apparatus 300a, the address information ADINFa of the notification apparatus 300a is stored while being associated with the network identification information IDNWa. Therefore, the identifier 120 identifies the address information ADINFa of the notification apparatus 300a. The address of the notification apparatus 300a is thus identified as the access destination of the terminal apparatus 100a.

Next, the requester 130 of the terminal apparatus 100a transmits an acquisition request REQaq to request acquisition of the interface information IFINFa of the quality control apparatus 200a, to the notification apparatus 300a, based on the address information ADINFa of the notification apparatus 300a identified by the identifier 120 (S120). The notification apparatus 300a thus receives the acquisition request REQaq of the interface information IFINFa from the terminal apparatus 100a (S300). The notification apparatus 300a then transmits the interface information IFINFa of the quality control apparatus 200a to the terminal apparatus 100a, as a response to the acquisition request REQaq received from the terminal apparatus 100a (S310).

The requester 130 of the terminal apparatus 100a thus receives the interface information IFINFa of the quality control apparatus 200a, from the notification apparatus 300a, as the response to the acquisition request REQaq (S130). In this way, the requester 130 acquires the interface information IFINFa of the quality control apparatus 200a, from the notification apparatus 300a, based on the address information ADINFa of the notification apparatus 300a identified based on the network information.

The requester 130 then transmits a start request REQst to request a start of the QoS control, to the quality control apparatus 200a, based on the interface information IFINFa acquired from the notification apparatus 300a (S140). For example, the start request REQst may include some or all of the items included in the interface information IFINFa acquired from the notification apparatus 300a (the items included in the interface information IFINF illustrated in FIG. 3).

The quality control apparatus 200a receives the start request REQst from the terminal apparatus 100a (S200). The quality control apparatus 200a then transmits an acknowledgement ACKst to the start request REQst, to the terminal apparatus 100a that is a transmission source of the start request REQst (S210). In addition, for example, the quality control apparatus 200a starts QoS control designated by the start request REQst (S220). The QoS control of the terminal apparatus 100a is thus started.

The terminal apparatus 100a receives the acknowledgement ACKst from the quality control apparatus 200a, as the response to the start request REQst (S150). The terminal apparatus 100a can thus recognize that QoS control according to the start request REQst has been started.

The requester 130 of the terminal apparatus 100a transmits an end request REQed to the quality control apparatus 200a in a case in which the QoS control of the terminal apparatus 100a is ended (S160).

The quality control apparatus 200a receives the end request REQed from the terminal apparatus 100a (S230). The quality control apparatus 200a then transmits an acknowledgement ACKed to the end request REQed, to the terminal apparatus 100a (S240). The terminal apparatus 100a thus receives the acknowledgement ACKed to the end request REQed, from the quality control apparatus 200a (S170). The quality control apparatus 200a ends the QoS control of the terminal apparatus 100a in accordance with the end request REQed (S250).

When the identifier 120 identifies the notification apparatus 300a, of the quality control apparatus 200a and the notification apparatus 300a, the requester 130 of the terminal apparatus 100a requests the notification apparatus 300a to acquire the interface information IFINFa of the quality control apparatus 200a. The requester 130 then requests the quality control apparatus 200a to start the QoS control, based on the interface information IFINFa acquired from the notification apparatus 300a.

Since it is assumed in the example illustrated in FIG. 5 that the terminal apparatus 100a connected to the network NWa transmits the start request REQst, the quality control apparatus 200b of the communication carrier managing the network NWb does not particularly implement processing regarding the QoS control of the terminal apparatus 100a.

Moreover, the operation of the network system 10 is not limited to the exemplary operation illustrated in FIG. 5. For example, in a case in which the quality control apparatus 200a is identified based on network information, the requester 130 of the terminal apparatus 100a may transmit the start request REQst for the QoS control to the quality control apparatus 200a, without transmitting the acquisition request REQaq to the notification apparatus 300a. That is, the requester 130 may request the quality control apparatus 200a identified by the identifier 120 based on the network information, to start the QoS control.

For example, in a case in which the QoS control designated by the start request REQst is not implementable, the quality control apparatus 200a may transmit a negative acknowledgement to the start request REQst, to the terminal apparatus 100a. In this case, the terminal apparatus 100a receives the negative acknowledgement from the quality control apparatus 200a, as the response to the start request REQst. The terminal apparatus 100a can thus recognize that QoS control according to the start request REQst is not started. For example, in the case in which the quality control apparatus 200a transmits the negative acknowledgement to the terminal apparatus 100a, the quality control apparatus 200a may transmit negative reason information indicative of why the QoS control is not implementable, to the terminal apparatus 100a.

For example, in order to utilize QoS control, an application carrier that provides an application program may incorporate a QoS control software development kit (SDK) for utilizing the QoS control into the application program. Information for transmitting a start request REQst (the interface information IFINF of each quality control apparatus 200 or the address information ADINF of each notification apparatus 300) is identified by each identifier 120 irrespective of a communication carrier that manages a network NW to which a terminal apparatus 100 having the application program installed therein is connected. As a result, according to the present embodiment, in creating an application program capable of requesting implementation of QoS control in each of the plurality of networks NW managed by the plurality of communication carriers, it is unnecessary to set a transmission destination of a start request REQst for the application program in accordance with a communication carrier. According to the present embodiment, therefore, the application program is less likely to be complicated.

For example, consideration may be given to such an aspect that, in a case in which the user of the terminal apparatus 100a makes a contract for a communication service in the network NWa, the communication carrier managing the network NWa sets the interface information IFINFa of the quality control apparatus 200a for the terminal apparatus 100a (hereinafter, also referred to as a comparative aspect). That is, according to the comparative aspect, the interface information IFINFa of the quality control apparatus 200a is set for the terminal apparatus 100 associated with the contract for the communication service in the network NWa. In other words, according to the comparative aspect, the interface information IFINFa of the quality control apparatus 200a is not set for a terminal apparatus 100 which is not associated with the contract for the communication service in the network NWa (hereinafter, also referred to as an uncontracted terminal apparatus 100). According to the comparative aspect, consequently, for example, in a case in which QoS control is applied to a terminal apparatus 100 that is present in a specific area irrespective of whether or not the contract for the communication service in the network NWa is made, there is a problem in that the QoS control is not applied to an uncontracted terminal apparatus 100.

In contrast to this, according to the present embodiment, the interface information IFINFa of the quality control apparatus 200a or the address information ADINFa of the notification apparatus 300a is identified by the identifier 120, irrespective of whether or not the contract for the communication service in the network NWa is made. Therefore, according to the present embodiment, for example, even in the case in which the QoS control is applied to a terminal apparatus 100 that is present in the specific area irrespective of whether or not the contract for the communication service in the network NWa is made, the QoS control is applicable to an uncontracted terminal apparatus 100.

According to the present embodiment described above, a terminal apparatus 100 includes an identifier 120, a requester 130, and the like. The identifier 120 identifies one or both of a quality control apparatus 200 and a notification apparatus 300 included in a network NW to which the terminal apparatus 100 is connected, based on network information for identifying the network NW to which the terminal apparatus 100 is connected. For example, the quality control apparatus 200 receives a request regarding QoS control that is control of quality of a communication service in the network NW to which the terminal apparatus 100 is connected. For example, the notification apparatus 300 receives an acquisition request REQaq to acquire interface information IFINF including information indicative of the quality control apparatus 200.

The requester 130 requests the quality control apparatus 200 to start the QoS control. For example, when the identifier 120 identifies the quality control apparatus 200, based on the network information, the requester 130 requests the quality control apparatus 200 identified by the identifier 120, to start the QoS control. For example, when the identifier 120 identifies the notification apparatus 300, of the quality control apparatus 200 and the notification apparatus 300, based on the network information, the requester 130 requests the notification apparatus 300 to acquire the interface information IFINF of the quality control apparatus 200. The requester 130 then requests the quality control apparatus 200 to start the QoS control, based on the interface information IFINF acquired from the notification apparatus 300.

As described above, according to the present embodiment, even in a case in which the interface information IFINF or the like of the quality control apparatus 200 is not previously set for the terminal apparatus 100, the identifier 120 identifies one or both of the interface information IFINF of the quality control apparatus 200 and address information ADINF of the notification apparatus 300. Therefore, according to the present embodiment, even in the case in which the interface information IFINF or the like of the quality control apparatus 200 is not previously set for the terminal apparatus 100, the quality control apparatus 200 can implement the QoS control of the terminal apparatus 100. As a result, according to the present embodiment, in creating an application program capable of requesting implementation of QoS control in each of the plurality of networks NW managed by a plurality of communication carriers, the application program is less likely to be complicated.

According to the present embodiment, for example, the interface information IFINF may further include one or both of terminal function information and QoS parameter information. For example, the terminal function information is indicative of a function of the terminal apparatus 100 and is required for receiving quality service to be achieved by the QoS control. For example, the QoS parameter information is indicative of a parameter to be notified to the quality control apparatus 200 in requesting a start of the QoS control.

For example, when the interface information IFINF includes the terminal function information, the requester 130 can determine whether the terminal apparatus 100 can receive the quality service achieved by the QoS control, before requesting the quality control apparatus 200 to start the QoS control. That is, the requester 130 can determine whether to request the quality control apparatus 200 to start the QoS control, based on the terminal function information included in the interface information IFINF.

For example, when the interface information IFINF includes the QoS parameter information, the requester 130 can notify the quality control apparatus 200 of a value of a parameter for QoS control, in requesting the quality control apparatus 200 to start the QoS control. For example, the requester 130 may add the value of the parameter for the QoS control to a start request REQst to request a start of the QoS control. That is, the requester 130 can appropriately request the quality control apparatus 200 to start the QoS control, based on the QoS parameter information included in the interface information IFINF.

According to the present embodiment, for example, the terminal apparatus 100 includes a storage device 160 storing correspondence information in which one or both of the interface information IFINF and the address information ADINF indicative of the notification apparatus 300 is or are associated with network identification information IDNW to be identified from the network information. In this case, the identifier 120 identifies one or both of the quality control apparatus 200 and the notification apparatus 300, based on the correspondence information and the network information. In an aspect in which the correspondence information is stored in the storage device 160, the identifier 120 can easily identify one or both of the quality control apparatus 200 and the notification apparatus 300 by referring to the correspondence information.

The storage device 160 may further store another correspondence information in which one or both of another interface information IFINF and another address information ADINF is or are associated with another network identification information IDNW. The other interface information IFINF includes information indicative of another quality control apparatus 200. The other address information ADINF is indicative of another notification apparatus 300. The other quality control apparatus 200 is a quality control apparatus 200 included in another network NW different from the network NW to which the terminal apparatus 100 is connected, among the plurality of networks NW, and configured to receive a request regarding QoS control to be implemented in the other network NW The other notification apparatus 300 is a notification apparatus 300 included in the other network NW and configured to receive a request for acquiring the other interface information IFINF. The other network identification information IDNW is network identification information IDNW to be identified from the other network information for identifying the other network NW.

In an aspect in which the correspondence information and the other correspondence information are stored in the storage device 160, also in a case in which the terminal apparatus 100 is connected to the other network NW, the identifier 120 can easily identify one or both of the quality control apparatus 200 and the notification apparatus 300 by referring to the another correspondence information. For example, the identifier 120 of the terminal apparatus 100 can easily identify one or both of the quality control apparatus 200 and the notification apparatus 300 by referring to a correspondence table TBL1 in which the correspondence information and the other correspondence information are stored.

In a case in which the correspondence information and the other correspondence information are managed by an external system, the identifier 120 acquires the correspondence information and the other correspondence information from the external system, and stores the correspondence information and the other correspondence information each acquired from the external system, in the storage device 160. With this configuration, for example, even in a case in which one or both of the quality control apparatus 200 and the notification apparatus 300 is or are changed, the identifier 120 can easily cope with the change of one or both of the quality control apparatus 200 and the notification apparatus 300. In the case in which the correspondence information and the another correspondence information are managed by the external system, the terminal apparatus 100 can implement reduced processing regarding the management of the correspondence information and another correspondence information.

According to the present embodiment, for example, in a case in which a module that stores subscriber identification information is attached to the terminal apparatus 100, the identifier 120 may refer to one, some, or all of the items included in information stored in the module as the network information, in order to identify one or both of the quality control apparatus 200 and the notification apparatus 300. The subscriber identification information is information identifying a user who subscribes to a communication service in the network NW (e.g., IMSI). For example, the module is a SIM. For example, the identifier 120 can easily identify one or both of the quality control apparatus 200 and the notification apparatus 300 by referring to some or all of the items included in the information stored in the module, as the network information.

According to the present embodiment, for example, the network information may include at least one of subscriber identification information, module identification information identifying a module that stores the subscriber identification information, and an access point name identifying an access point for connection to the network NW. Also in this case, the identifier 120 can easily identify one or both of the quality control apparatus 200 and the notification apparatus 300, based on the network information.

### 2. MODIFICATION EXAMPLES

The present invention is not limited to the embodiment exemplified above. Specific modified aspects are exemplified below. Two or more aspects optionally selected from the following examples may be combined.

### First Modification Example

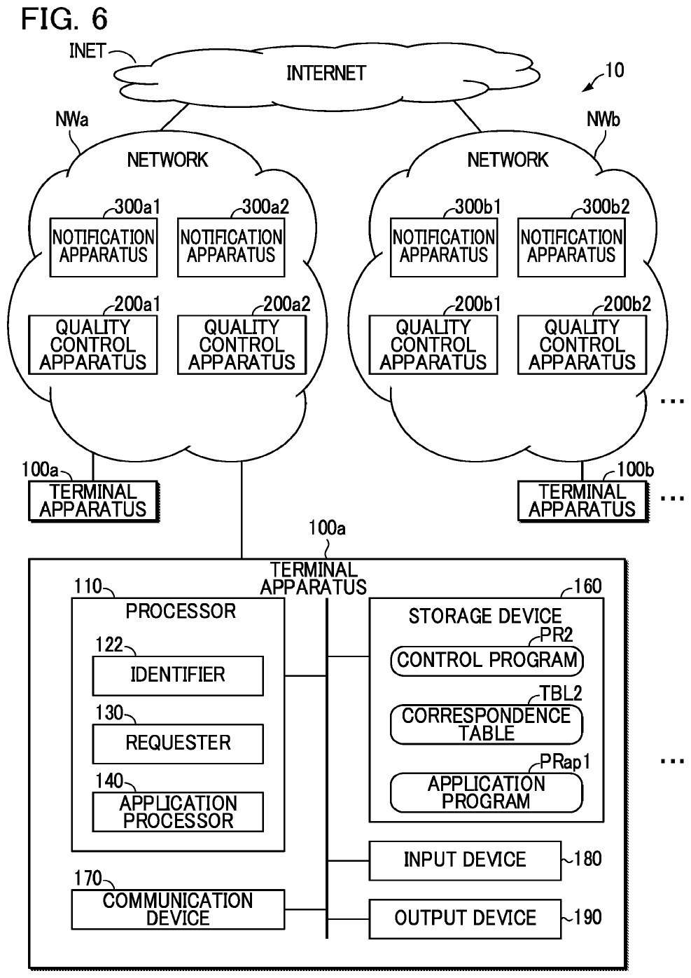

The foregoing embodiment does not particularly describe a relationship between an inquiry destination for requesting QoS control (e.g., a notification apparatus 300, etc.) and information obtained from an application program. For example, the inquiry destination for requesting the QoS control may differ depending on the information obtained from the application program. For example, each terminal apparatus 100 may include an identifier 122 configured to identify one or both of the corresponding quality control apparatus 200 and the corresponding notification apparatus 300, based on network information and information obtained from an application program (see FIG. 6). For example, the information obtained from the application program may be information indicative of a type of the application program or may be information instructed by the application program. Alternatively, the information obtained from the application program may be information including information indicative of a type of the application program and information instructed by the application program.

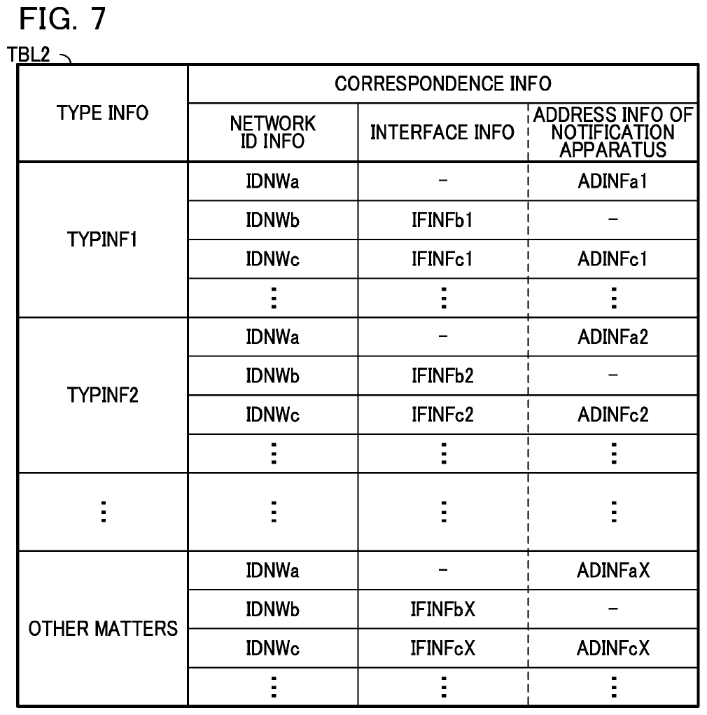

Examples of the type of the application program include a game, a streaming service, a telephone calling service, and the like. For example, in a case in which the application program selects one kind of QoS control from multiple kinds of QoS control supported by the quality control apparatus 200, the information instructed by the application program may be information indicative of an instruction regarding the selection of the QoS control or details of settings. It is assumed in FIGS. 6 and 7, to be described later, that the information obtained from the application program is the information indicative of the type of the application program.

FIG. 6 is a block diagram illustrating a general configuration of a network system 10 including a terminal apparatus 100 according to a first modification example. In FIG. 6, elements substantially the same as the elements described with reference to FIGS. 1 to 5 are denoted by identical reference signs; therefore, detailed description of the elements will not be given here. The network system 10 illustrated in FIG. 6, which is substantially the same as the network system 10 illustrated in FIG. 1, includes a plurality of networks NW connected to each other via the Internet INET, and a plurality of terminal apparatuses 100 respectively connected to the plurality of networks NW. It is however assumed in FIG. 6 that networks NWa and NWb each include a plurality of quality control apparatuses 200 and a plurality of notification apparatuses 300. For example, the network NWa includes quality control apparatuses 200a1 and 200a2, and notification apparatuses 300a1 and 300a2. The network NWb includes quality control apparatuses 200b1 and 200b2, and notification apparatuses 300b1 and 300b2.

The terminal apparatuses 100 are substantially the same as the terminal apparatuses 100 illustrated in FIG. 1. For example, each terminal apparatus 100 is implemented using a computer system including a processor 110, a storage device 160, a communication device 170, an input device 180, and an output device 190. However, the terminal apparatuses 100 illustrated in FIG. 6 are different from the terminal apparatuses 100 illustrated in FIG. 1 in a respect that each storage device 160 stores a control program PR2, an application program PRap1, and a correspondence table TBL2 and in a respect that each processor 110 implements the control program PR2 and the like. It should be noted that the control program PR2, the application program PRap1, the correspondence table TBL2, and the like may be transmitted from another apparatus via the corresponding network NW. In the following, the application program may be collectively referred to as an application program PRap irrespective of whether or not the application program is the application program PRap1.

For example, the processor 110 reads the control program PR2 from the storage device 160 and implements the read control program PR2, thereby functioning as an identifier 122 and a requester 130. In addition, the processor 110 reads the application program PRap1 from the storage device 160 and implements the read application program PRap1, thereby functioning as an application processor 140.

It is assumed in the following description that the application program PRap1 and the control program PR2 are implemented in parallel. It is also assumed in the following description that an inquiry destination for requesting QoS control differs depending on a type of the application program PRap. For example, the application program PRap for the quality control apparatus 200a1 and the notification apparatus 300a1 is different in type from the application program PRap for the quality control apparatus 200a2 and the notification apparatus 300a2. For example, the application program PRap for the quality control apparatus 200b1 and the notification apparatus 300b1 is different in type from the application program PRap for the quality control apparatus 200b2 and the notification apparatus 300b2.

For example, the identifier 122 identifies one or both of the corresponding quality control apparatus 200 and the corresponding notification apparatus 300, based on network information and type information TYPINF indicative of the type of the application program PRap (see FIG. 7). The other operations of the identifier 122 are substantially the same as those of each identifier 120 illustrated in FIG. 1. It should be noted that the type information TYPINF is one example of “information obtained from an application program”.

The requester 130 is substantially the same as each requester 130 illustrated in FIG. 1. The application processor 140 implements processing based on the application program PRap1.

It should be noted that the configurations of each terminal apparatus 100, quality control apparatus 200, and notification apparatus 300 are not limited to the exemplary configurations illustrated in FIG. 6. For example, the number of notification apparatuses 300 included in each of the plurality of networks NW may be one. In this case, the requester 130 of the corresponding terminal apparatus 100 may add type information TYPINF to an acquisition request REQaq to be transmitted to the notification apparatus 300. The notification apparatus 300, when receiving the acquisition request REQaq including the type information TYPINF, may transmit interface information IFINF of the quality control apparatus 200 according to the type of the application program PRap, to the terminal apparatus 100, as a response to the acquisition request REQaq.

FIG. 7 is an explanatory diagram illustrating one example of the correspondence table TBL2 illustrated in FIG. 6. For example, the correspondence table TBL2 stores correspondence information that is substantially the same as that stored in the correspondence table TBL1 illustrated in FIG. 2, for each type of the application program PRap. In FIG. 7, the row “Other Matters” about the type information is referred to when an application program PRap that is not classified as the type of the application program PRap registered in the correspondence table TBL2 is implemented.

It should be noted that the data configurations of the correspondence table TBL2 are not limited to the exemplary data configurations illustrated in FIG. 7. For example, records associated with the respective networks NW each may include a plurality of sub-records having one-to-one correspondence with multiple types of the application program PRap. The correspondence table TBL2 may be made available to the public via the Internet INET and the like. Alternatively, the correspondence table TBL2 may be stipulated by standardization or the like or may be distributed by an application carrier or the like.

According to the first modification example described above, for example, the identifier 122 identifies one or both of the quality control apparatus 200 and the notification apparatus 300, based on the network information and the type information TYPINF indicative of the type of the application program PRap. For example, in a case in which the information obtained from the application program PRap is information instructed by the application program PRap, the type information TYPINF may be read as the information instructed by the application program PRap. The first modification example can also produce advantageous effects substantially the same as those in the foregoing embodiment. According to the first modification example, for example, even in a case in which a quality control apparatus 200 configured to implement QoS control is provided for each type of an application program PRap, it is possible to easily identify one or both of a quality control apparatus 200 and a notification apparatus 300.

### Second Modification Example

The foregoing embodiment and the first modification example each describe the case in which the identifier 120 or 122 of each terminal apparatus 100 refers to the information stored in the SIM or the information set for the terminal apparatus 100, as the network information; however, the present invention is not limited to such an aspect. For example, each terminal apparatus 100 (e.g., each identifier 120 or 122) may acquire, as network information, a part of, or the entirety of, the procedure information indicative of details of processing for a connection procedure to be carried out between the terminal apparatus 100 and the corresponding network NW, for connection to the network NW The second modification example can also produce advantageous effects substantially the same as those in the foregoing embodiment and first modification example.

### Third Modification Example

None of the foregoing embodiment, the first modification example, and the second modification example particularly describe whether interface information IFINF acquired from each notification apparatus 300 is discarded. For example, interface information IFINF acquired from each notification apparatus 300 may be stored in the correspondence table TBL1 or TBL2. Specifically, each terminal apparatus 100 (e.g., each requester 130) may store interface information IFINF acquired from the corresponding notification apparatus 300, in the correspondence table TBL1 or TBL2. In this case, for example, when the terminal apparatus 100 is connected to the corresponding network NW again, the identifier 120 (or 122) can identify the interface information IFINF of the corresponding quality control apparatus 200, based on the correspondence table TBL1 (or TBL2). With this configuration, according to the third modification example, it is possible to inhibit increase in frequency of transmitting an acquisition request REQaq to the notification apparatus 300. As a result, according to the third modification example, it is possible to make operation of the terminal apparatus 100 less likely to become complicated in requesting a start of QoS control.

### 3. Other Matters

(1) In each embodiment described above, the storage device 160 is a recording medium readable by the processor 110, and although ROM and RANI have been given as examples, may be constituted by, for example, a flexible disk, a magnetic optical disk (e.g., a compact disc, a digital versatile disc, a Blu-ray (registered trademark) disk, etc.), a smart card, a flash memory device (e.g., a card, a stick, a key drive, etc.), a CD-ROM (Compact Disc-ROM), a register, a removable disk, a hard disk, a floppy (registered trademark) disk, a magnetic stripe, a database, a server, and/or other appropriate storage media. A program may be transmitted via a telecommunication line network from the network. A program may be transmitted via a telecommunication line network from the communication network.

(2) The aspects and embodiments described herein are applicable to at least one of systems utilizing long term evolution (LTE), LTE-advanced (LTE-A), SUPER 3G, IMT-Advanced, 4th generation mobile communication system (4G), 4th generation mobile communication system (5G), future radio access (FRA), new radio (NR), W-CDMA (registered trademark), GSM (registered trademark), CDMA2000, Ultra Mobile Broadband (UMB), IEEE 802.11 (Wi-Fi), IEEE 802.16 (WiMax (registered trademark)), IEEE 802.20, Ultra-WideBand (UWB), Bluetooth (registered trademark), systems using other proper systems, and next generation systems extended based thereon, or to a combination of more than one system (e.g., a combination of at least one of LTE or LET-A and 5G).

(3) In each embodiment described above, the information, signals and/or other matters that have been described may be represented by using a variety of different technologies. For example, data, instructions, commands, information, signals, bits, symbols and chips, all of which may be referenced throughout the herein-contained description, may be represented by voltages, currents, electromagnetic waves, magnetic fields or particles, optical fields or photons, or any combinations of these.

(4) In each embodiment described above, the information or the like that are input or output may be stored in a specific place (for example, in a memory) or may be managed using a management table. The information and/or the like that are input and/or output can be overwritten, updated, or added. The information and/or the like that are input and/or output may be deleted. The information and/or the like that are input and/or output may be transmitted to other apparatuses.

(5) In each embodiment described above, determinations may be made based on values represented by one bit (0 or 1), may be made based on Boolean values (“true” or “false”), or may be made by comparing numerical values (for example, based on comparison with a predetermined value).

(6) The order of processes, sequences, flowcharts, etc., in each embodiment described above may be re-ordered as long as conflicts do not arise. For example, although various methods have been described in this specification with various components of steps in exemplary orders, the specific orders illustrated herein are by no means limiting.

(7) The functions exemplarily shown in FIGS. 1, etc., are realized by any combination of at least one of hardware and software. Furthermore, each function block may be realized by any method. Each function block may be realized by a single apparatus physically or logically coupled, or by two or more physically or logically separated apparatuses connected directly or indirectly (e.g., by wire or wirelessly). Function blocks may be realized by the single apparatus or two or more apparatuses in combination with software.

The communication device 170 is a hardware (transceiver device) that communicates with other apparatuses through at least one of a wired network or a wireless network, and is also referred to as, for example, a network device, a network controller, a network card, or a communication module. The communication device 170 may be configured to include high-frequency switches, duplexers, filters, frequency synthesizers, etc., to realize at least one of a Frequency Division Duplex (FDD) or Time Division Duplex (TDD).

(8) The program illustrated in each embodiment described above should be broadly interpreted so as to refer to an instruction, an instruction set, a code, a code segment, a program code, a program, a sub program, a software module, an application, a software application, a software package, a routine, a subroutine, an object, an executable file, an executable thread, an execution thread, a procedure, a function or the like, regardless of whether the program is called software, firmware, middleware, microcode, or a hardware description language, or is called something else.

Furthermore, the software, the instructions, and the like may be transmitted and received through a transmission medium. For example, in a case in which the software is transmitted from at least one of a website, a server, or any other remote source using a wired technology, such as a coaxial cable, an optical fiber cable, a twisted pair, and a digital subscriber line (DSL), or a wireless technology such as an infrared, radio waves, and microwaves, at least one of these wired technologies or the wireless technologies are included within the definition of the transmission medium.

(9) In each embodiment described above, the term “systems” and “networks” may be used interchangeably.

(10) The information and parameters, etc., in each embodiment described above may be represented in absolute values, may be represented in relative values with respect to predetermined values, or may be represented using other applicable pieces of information. For example, radio resources may be specified using indices. The names used for the parameters described above are not limiting names in any respect. Furthermore, the mathematical formulas and other formulas using these parameters may differ from those explicitly disclosed in the present disclosure. Since the various channels (e.g., PDCCH, PDCCH, etc.) and information elements can be identified by any suitable name, the various names assigned to these various channels and information elements are not in any way limiting names.

(11) In each embodiment described above, there is included a case in which the terminal apparatus 100 is a mobile station (MS). A mobile station may be referred to, by one skilled in the art, as a “subscriber station”, a “mobile unit”, a “subscriber unit”, a “wireless unit”, a “remote unit”, a “mobile device”, a “wireless device”, a “wireless communication device”, a “remote device”, a “mobile subscriber station”, an “access terminal”, a “mobile terminal”, a “wireless terminal”, a “remote terminal”, a “handset”, a “user agent”, a “mobile client”, a “client” or some other suitable terms. Furthermore, in the present disclosure, the terms such as a “mobile station”, a “user terminal”, “user equipment (UE)”, a “terminal”, etc., may be used interchangeably.

(12) In each embodiment described above, the term “connected”, “coupled”, and all the other variations of these terms mean all direct or indirect connections or coupling between two or more elements, and may indicate the presence of one or more intermediate elements between two elements that are “connected” or “coupled” with each other. The coupling or connection between these elements may be physical or logical, or may be a combination of these. For example, “connection” may be read as “access”. As used herein, two elements may be considered “connected” or “coupled” to each other by using at least one of one or more electrical wires, cables or printed electrical connections, and as non-limiting and non-inclusive examples, by using electromagnetic energy, such as electromagnetic energy having wavelengths in radio frequency regions, microwave regions and optical (both visible and invisible) regions.

(13) In each embodiment described above, the phrase “based on” does not mean “based only on” unless otherwise specified. In other words, the phrase “based on” means both “based only on” and “based at least on”.

(14) The term “determining” as used in the present description may include a variety of different operations. For example, an act of having judged, calculated, computed, processed, derived, investigated, looked up (for example, in a search of a table, database, or other data construct), or ascertained, may be considered as having been “determined”. In addition, an act of having received (e.g., received information), transmitting (e.g., transmitting information), input, output, or accessed (e.g., accessed data in a memory), may be considered as having “determined”. In addition, an act of having resolved, selected, chosen, established, or compared may be considered as having “determined”. In other words, to “determine” may include anything that can be considered to have “determined” some kind of operation. Furthermore, to “determine” may be read as one of “assuming”, “expecting”, “considering”, etc.

(15) In each embodiment described above, terms such as “include”, “including”, and variations of these are used in this specification or claims, these terms are intended to be inclusive, in a manner similar to the way the term “comprising” is used. Furthermore, the term “or” as used in this specification or claims is not intended to be an exclusive disjunction.

(16) In the present disclosure, in a case in which articles are added in the translation, for example, “a”, “an”, or “the” in English, these articles include plural forms, unless it is clearly indicated by the context that they do not.

(17) In the present disclosure, a phrase “A and B are different” may mean “A and B are different from each other”. The phrase “A and B are different” may mean “A and B each are different from C”. A term such as “away from” and “coupled” may be interpreted as “away from each other” and “coupled with each other” in the same manner.

(18) Each of the aspects/embodiments described in this disclosure may be used alone, in combination, or be switched as it is executed. Notifying predetermined information (e.g., notification of “being X”) is not limited to explicit notification, but may also be performed implicitly (e.g., by not notifying the predetermined information).

Although the present disclosure has been described in detail above, it should be obvious to one skilled in the art that the present disclosure is by no means limited to the embodiment described herein. The present disclosure can be implemented with a variety of corrections and in a variety of variations, without departing from the spirit and scope of the present invention defined by the recitation of claims. Consequently, the description herein is provided only for the purpose of explaining examples, and should by no means be construed to limit the present invention in any way.

### DESCRIPTION OF REFERENCE SIGNS

10: Network system, 100: Terminal apparatus, 110: Processor, 120, 122: Identifier, 130: Requester, 140: Application processor, 160: Storage device, 170: Communication device, 180: Input device, 190: Output device, 200: Quality control apparatus, 300: Notification apparatus.

1. A terminal apparatus to be connected to a network among a plurality of networks in which quality of a communication service is controlled, the terminal apparatus comprising:
an identifier configured to identify, based on network information for identifying the network, one or both of a first node and a second node, wherein:
the first node is configured to receive a request regarding quality control that is control of quality of a communication service in the network, and
the second node is configured to receive a request to acquire first information including information indicative of the first node; and
a requester configured to request the first node to start the quality control.

2. The terminal apparatus according to claim 1, wherein the first information further includes one or both of terminal function information indicative of a function of the terminal apparatus and parameter information indicative of a parameter to be notified to the first node in requesting a start of the quality control, the terminal function information and the parameter information being required for receiving quality service achieved by the quality control.

3. The terminal apparatus according to claim 1, wherein, in a case in which the identifier identifies only the second node, among the first node and the second node, the requester is configured to request the second node to acquire the first information, and request the first node to start the quality control, based on the first information acquired from the second node.

4. The terminal apparatus according to claim 1, further comprising a storage device configured to store correspondence information in which one or both of the first information and second information indicative of the second node are associated with third information identified by the network information,
wherein the identifier is configured to identify one or both of the first node and the second node, based on the correspondence information and the network information.

5. The terminal apparatus according to claim 4, wherein:
the storage device is configured to further store another correspondence information in which one or both of another first information and another second information are associated with another third information,
the another first information includes information indicative of another first node configured to receive a request regarding quality control implemented for another network of the plurality of networks,
the another second information is indicative of another second node configured to receive a request to acquire the another first information, and
the another third information is identified by another network information for identifying the another network.

6. The terminal apparatus according to claim 5, wherein, in a case in which the correspondence information and the another correspondence information are managed by an external system, the identifier is configured to acquire the correspondence information and the another correspondence information from the external system, and store the correspondence information and the another correspondence information each acquired from the external system, in the storage device.

7. The terminal apparatus according to claim 1, wherein, in a case in which a module is attached to the terminal apparatus, the module being configured to store subscriber identification information identifying a user who subscribes to the communication service in the network, the identifier is configured to refer to at least one of items included in information stored in the module as the network information, in order to identify one or both of the first node and the second node.

8. The terminal apparatus according to claim 1, wherein the network information includes at least one of subscriber identification information identifying a user who subscribes to the communication service in the network, module identification information identifying a module configured to store the subscriber identification information, and an access point name identifying an access point for connection to the network.

9. The terminal apparatus according to claim 1, wherein the identifier is configured to identify one or both of the first node and the second node, based on information obtained from an application program and the network information.

10. A method for controlling a terminal apparatus to be connected to a network among a plurality of networks in which quality of a communication service is controlled, the method comprising:
identifying, based on network information for identifying the network, one or both of a first node and a second node, wherein:
the first node is configured to receive a request regarding quality control that is control of quality of a communication service in the network, and
the second node is configured to receive a request to acquire first information including information indicative of the first node; and
requesting the first node to start the quality control.

11. The terminal apparatus according to claim 2, wherein, in a case in which the identifier identifies only the second node, among the first node and the second node, the requester is configured to request the second node to acquire the first information, and request the first node to start the quality control, based on the first information acquired from the second node.
